(19) United States
(12) Patent Application Publication
(10) Pub. No.: US 2018/0216385 A1
(43) Pub. Date: Aug. 2, 2018

(54) HYDRAULIC HINGES WITH AN INTEGRATED SOFT-CLOSURE SYSTEM WITH A REGULATORY BASE AND ADJUSTABLE SCREWS

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 15/746,332

(22) PCT Filed: Apr. 28, 2016
(86) PCT No.: PCT/MX2016/000043

§ 371 Date: Jan. 19, 2018

(30) Foreign Application Priority Data
Apr. 27, 2016 (MX) MX/U/2016/000176

(51) Int. Cl. E05F 3/20; E05D 3/14; E05D 7/04; E05F 3/06

(52) U.S. Cl. CPC E05F 3/20; E05D 3/142; E05D 7/0423; E05D 7/0407; E05F 3/06; E05Y 2900/20; E05Y 2201/212; E05Y 2201/41; E05Y 2201/484; E05Y 2600/12; E05Y 2600/20; E05D 2007/0492

(57) ABSTRACT

A hydraulic hinge with a soft-closure integrated system with a regulatory base and adjustable screws, the hydraulic hinge comprising: a main coupling container body; a top cover; a soft-closure adjuster screw; a depth-adjustable screw; a right and left lateral adjustable screw; a height-from-door adjustable screw; four guided rivets; a primary union neck; a union lock; a bowl-shape pushing piece; a closure spring; two stabilizer bushings; a slow-closure neck; a slow-closure yoke; a hydraulic piston; an easy-installation support base; a regulatory support base; two coupling pluralities holes; a coupling plurality of two parallel arms located at the center of the regulatory support base; and a guide rivet that it axially goes from one side to the other side.

### PREVIEWS OF THE INVENTION

Nowdays, there are known a great variety of hinges, for example the adjustables hinges or the collapsible, or well the conventionals with basic functions, such hinges do not count with a regulatory base and regulating screws, height-regulating, depth-regulating, and the laterals. The previous examples have a limitation, that they are not reinforced with resistant materials, they are very noisy, and that with the daily doors use, they lose their functions, or they deteriorate with the sun's exposure, to the rain, or the salinity.

The present invention seeks to solve this technical problem, by adding an integrated soft-closure system with a regulatory base, a height-adjustable, depth-adjustables, and left & right lateral screws, and resistant materials to the sun, the rain, and the salinity.

### DESCRIPTION OF THE INVENTION

The novelty of this invention is clearly shown in the drawings that are attached with the present application, and according to the description that we detail below in mode that the alpha-numeric references do correspond to each one of the structure's elements that belongs in this invention.

### BRIEF DESCRIPTION OF THE FIGURES

FIG. 1 is a view of the seal of the hydraulic hinge with an integrated soft-closure system with a regulatory base and adjustables screws, and structural parts that compose it.

FIG. 2 is a perspective view of the hydraulic hinge with an integrated soft-closure system with a regulatory base and adjustables screws; showing the regulatory base up.

FIG. 3 is a view in plant of the hydraulic hinge with an integrated soft-closure with a regulatory base and adjustables screws; showing the regulatory base, right-lateral & left-laterals.

FIG. 4 is an aerial view of the hydraulic hinge with an integrated soft-closure system with a regulatory base and adjustables screws; showing the height-regulator screw and depth-regulator screw.

FIG. 5 is a perspective view of the hydraulic hinge with an integrated soft-closure system with a regulatory base and adjustables screws; showing the regulator screw, right-lateral & left lateral.

### IN-DETAIL DESCRIPTION OF THE INVENTION

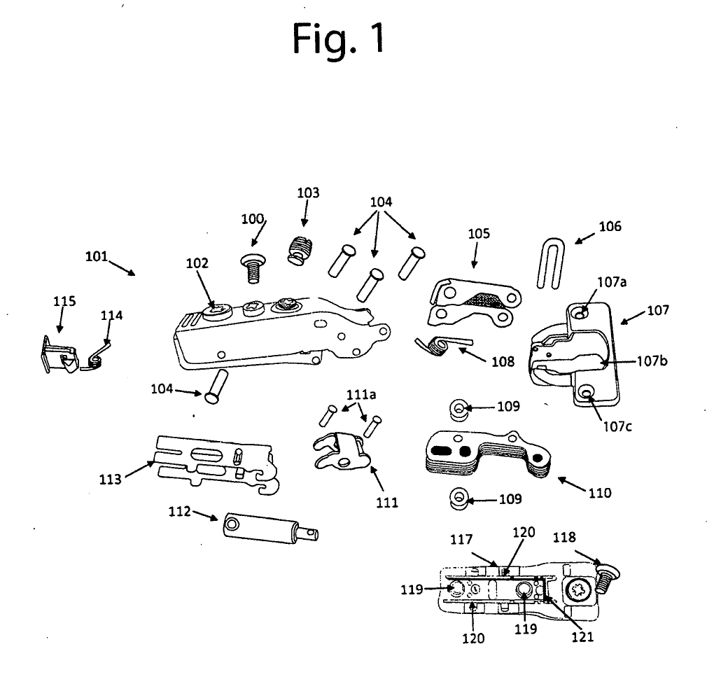

With reference to FIG. 1, the hydraulic hinge with an integrated soft-closure system with a regulatory base and adjustables screws, that comprehends a main coupling container body (101), a top cover with three holes' pluralities, not illustrated, a soft-closure adjuster screw (100)

Set at the center of the top cover, a depth-adjustable screw (102) located in the right side at the top cover; a lateral-right and lateral-left adjustable screw (103), set at the top cover left-side; four guided rivets (104) located longitudinally in the main coupling container body, a primary union neck (105) located in between the main coupling container body and the bowl-shape pushing piece; a bowl-shape pushing piece's union lock (106) that unites the bowl-shape pushing piece and the main coupling container body, a bowl-shape pushing piece's body (107) that comprehends two pluralities of extreme right fixing holes and pluralities of extreme left-side fixing holes (107^{a}) and extreme left-side (107b), and a plurality of accommodation (107c); a closure spring (108) located at the main right-side container body, and the left-side bowl-shape pushing piece, which together with the piston (112) provides tension and softness at doors' closure, two stabilizer-bushings (109) set at the slow-closure neck, a slow-closure neck (110) located at the primary union neck, a slow-closure yoke (111) located at the main coupling container (101) and it holds to the right-side piston (112) to bring about the soft-closure function, with two fixing rivets (111^{a}), a hydraulic piston (112) located at the main coupling container body, an easy-installation support base (113) located at the main coupling container body that it comprehends an activator-lock spring (114) of attachment for the regulatory support (117) set at the easy-installation support base, a fixing lock to the support (115) set on the left-side of the easy-installation support base, a regulatory base (117), characterized because it comprehends a left-side regulating screw (118), two coupling pluralities holes (119) right-side and left-side; a coupling of two parallel-arms' plurality (120) which they extend longitudinally; set at the central part of the regulating base; which it comprehends a rivet guide that it extends axially from one extreme side to the other side (121).

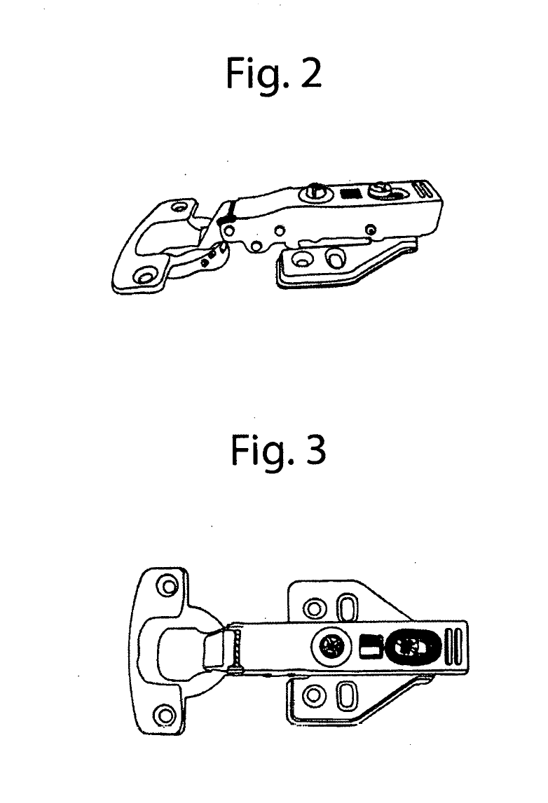

With reference to FIG. 2, the hydraulic hinge with regulatory base and adjustables screws, that illustrate the adjustable screw; that illustrate the height-adjustable screw (102) that can be of +2.5 mm to −2.0 mm.

With reference to FIG. 3, the hydraulic hinge with regulatory base and adjustables screws; it illustrate the lateral adjustable screw (103) right-side & left-side, that can be of 2.0 mm or −2.0 mm.

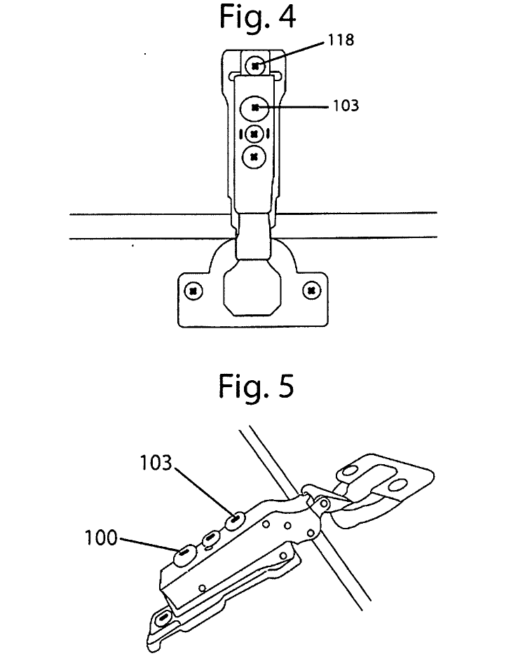

With reference to FIG. 4, the hydraulic hinge with regulatory base and adjustables screws; that it in detail illustrates the door's height-adjustable screw (118), and the depth-adjustable screw (102).

With reference to FIG. 5, the hydraulic hinge with regulatory base and adjustables screws; that it in detail illustrate the elevation adjustable screw for the door's right & left lateral adjustments (103).

The hydraulic hinge with an integrated soft-closure system, with a regulatory base and adjustables screws is designed for applications on swing doors; each pair approximately supports doors with weight less-than to 7 kilograms. The integrated soft-closure system helps to the door's softly and quietly slide on the route towards a complete closure, furthermore to have a soften closure, the design allows its installment on doors with heights no more than a 1 meter and widths up to 60 cm. The measurements are proportional to the door's weight, and considering the use of a pair of these hinges, in case of using more hinges, the measurements can be bigger, such as the total load's weight.

The hydraulic hinge with an integrated soft-closure system, with a regulatory base and adjustables screws is designed for an easy installation and montage, the installation of the complete hinge it is done within the vain.

The hydraulic hinge with an integrated soft-closure system, with a regulatory base and adjustables screws has a design that allows an easy handling and montage, in virtue to the hinge is latch on, into two parts, which are of an easy assembly and fixation. The first part is the main coupling container body (101) and the regulatory base (117) with adjustables screws, which are pin up on the furniture, giving a smooth handling at the door for the assembly. The second part is the bowl-shape pushing piece (107) which function consists in to unify the door to the furniture, both parts are united and set by the union lock (106). The design in the necks, both primary (105) as well as the closure one (110); it allows to place the doors on the furniture's frame; it gives a cover space up to 16 mm.

From the furniture's edge to the furniture, the integrated spring (108) helps at the closure of the door and together with the piston (112), it provides a noiseless closure, the soft-closure adjustor screw allows the regulation of the closure's intensity. The material used in its manufacturing is stainless steel it gives an edge at high-salinity level zones, it adds to the ironwork's life.

1. A hydraulic hinge with a soft-closure integrated system with a regulatory base and adjustable screws, the hydraulic hinge comprising:
a main coupling container body;
a top cover;
a soft-closure adjuster screw;
a depth-adjustable screw;
a right and left lateral adjustable screw;
a height-from-door adjustable screw;
four guided rivets;
a primary union neck;
a union lock;
a bowl-shape pushing piece;
a closure spring;
two stabilizer bushings;
a slow-closure neck;
a slow-closure yoke;
a hydraulic piston;
an easy-installation support base;
a regulatory support base;
two coupling pluralities holes, left and right;
a coupling plurality of two parallel arms located at the center of the regulatory support base; and
a guide rivet that it axially goes from one side to the other side.

2. A hydraulic hinge with a soft-closure system with a regulatory base and adjustable screws according to claim 1, further comprising:
a superior top with three assembly plurality holes.

3. A hydraulic hinge with a soft-closure system with a regulatory base and adjustable screws according to claim 1, further comprising:
a depth-adjustable screw.

4. A hydraulic hinge with a soft-closure system with a regulatory base and adjustable screws according to claim 1, further comprising:
an adjustable right-lateral and left-lateral screw.

5. A hydraulic hinge with a soft-closure system with a regulatory base and adjustable screws according to claim 1, further comprising:
four guide rivets.

6. A hydraulic hinge with a soft-closure system with a regulatory base with adjustable screws according to claim 1, further comprising:
a primary union neck.

7. A hydraulic hinge with a soft-closure system with a regulatory base and adjustable screws according to claim 1, further comprising:
an union lock.

8. A hydraulic hinge with an integrated soft-closure system with a regulatory base and adjustable screws according to claim 1, further comprising:
a bowl-shape pushing piece with two holding holes pluralities, extreme right and extreme left; and
an accommodation plurality.

9. A hydraulic hinge with an integrated soft-closure system with a regulatory base and adjustable screws according to claim 1, further comprising:
one closed spring.

10. A hydraulic hinge with an integrated soft-closure system with a regulatory base and adjustable screws according to claim 1, further comprising:
a slow-closure neck with two stabilizer-bushings.

11. A hydraulic hinge with an integrated soft-closure system with a regulatory base and adjustable screws according to claim 1, further comprising:
a slow-closure yoke with two guided-rivets.

12. A hydraulic hinge with an integrated soft-closure system with a regulatory base and adjustable screws according to claim 1, further comprising:
a hydraulic piston.

13. A hydraulic hinge with an integrated soft-closure system with a regulatory base and adjustable screws according to claim 1, further comprising:
an easy installation support base.

14. A hydraulic hinge with an integrated soft-closure system with a regulatory base and adjustable screws according to claim 1, further comprising:
a lock-activator spring.

15. A hydraulic hinge with an integrated soft-closure system with a regulatory base and adjustable screws according to claim 1, further comprising:
a fixing lock to support lock.

16. A hydraulic hinge with an integrated soft-closure system with a regulatory base and adjustable screws according to claim 1, further comprising:
a regulatory base with an adjustable left-side adjustable-screw.

17. A hydraulic hinge with an integrated soft-closure system with a regulatory base and adjustable screws according to claim 16, further comprising:
two assembly pluralities holes, right lateral and left lateral.

18. A hydraulic hinge with an integrated soft-closure system with a regulatory base and adjustable screws according to claim 16, further comprising:
an assembly plurality with two parallel arms.
